(19) United States
(12) Patent Application Publication
(10) Pub. No.: US 2012/0319603 A1
(43) Pub. Date: Dec. 20, 2012

(54) METHOD TO SUPPLY POWER TO AN LED ARRAY AS WELL AS THE CIRCUIT ARRANGEMENT FOR IMPLEMENTING THE METHOD

(75) Inventors: Stefan Möller, Lippstadt (DE); Ralf Edelmeier, Herzebrock-Clarholz (DE); Stefan Kaiser, Bielefeld (DE)

(73) Assignee: HELLA KGaA, Lippstadt (DE)

(21) Appl. No.: 13/582,393

(22) PCT Filed: Mar. 1, 2010
(86) PCT No.: PCT/EP2010/052535

§ 371 Date: Aug. 31, 2012

(51) Int. Cl. H05B 37/00

(52) U.S. Cl. 315/192

(57) ABSTRACT

The present invention relates to a method to supply power to an LED array, comprising at least two LED branches connected in parallel, in each of which at least one LED is arranged. The LED array is supplied with predetermined power from a current source connected in series, wherein currents are measured in the LED branches, wherein the measured currents are compared in control electronics, and wherein the currents are controlled in a part of the LED branches such that they have a defined ratio with respect to one another in the LED branches. The method is intended to be improved such that it can be carried out economically and with simple means. This is achieved in that one of the LED branches is selected to be the master whose current is utilized as the target specification for the remaining LED branches.

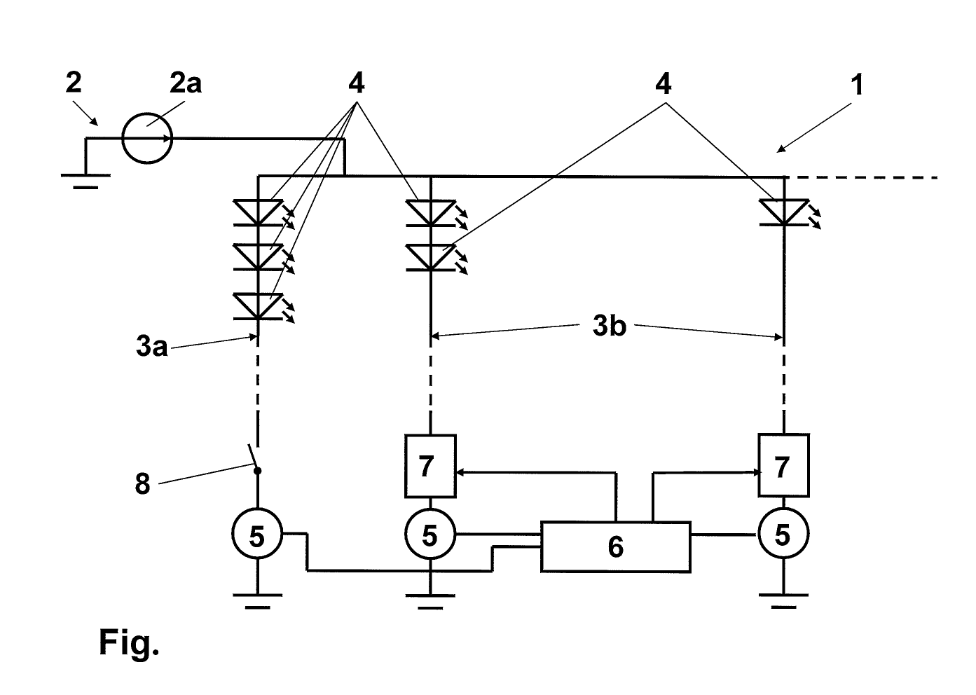

The invention further relates to a circuit arrangement for implementing the method according to the invention as well as a lighting unit with such type of circuit arrangement.

The present invention relates to a method to supply power to an LED array, comprising at least two LED branches connected in parallel, in each of which at least one LED is arranged. The LED array is supplied with predetermined power from a current source connected in series, wherein currents are measured in the LED branches, wherein the measured currents are compared in control electronics, and wherein the currents are controlled in a part of the LED branches such that they are in a defined ratio with respect to one another in all LED branches.

The invention further relates to a circuit arrangement for implementing the method as well as a corresponding lighting unit.

Such types of methods and circuit arrangements are already known from the prior art in a plurality of embodiments.

For example, EP 1 449 408 B1 discloses a method for supplying power to an LED array as well as a corresponding circuit arrangement. This switching arrangement for an LED array has at least two LED branches connected in parallel in each of which at least one LED is connected to a controllable resistor in series. The controllable resistors in this case are part of control electronics. The LED array is connected to a voltage source. In order to achieve a specified distribution of the currents to the LED branches, even with differing forward voltages or with a change in the forward voltages, EP 1 449 408 B1 proposes adjusting the current in the individual LED branches via the controllable resistors designed as transistors such that they are at approximately 0.65 V less than the common basis potential at the voltage dropping at the emitter resistors. The currents in the individual LED branches are thus controlled such that the voltages are equalized at the emitter resistors. The known circuit arrangement should be particularly suitable in that the current distribution specified by the dimensioning of the emitter resistors can also be maintained for the remaining LED branches even if one LED branch fails.

DE 10 2006 005 521 B3 describes a method for actuating an LED array with at least two LED branches (strings) comprising a controller unit as well as a switch and a resistor in each of the branches. The switches are controlled by the controller unit. Voltage to the LED array is controlled. The control unit is a microprocessor that is programmed accordingly or a customer-specific integrated circuit (ASIC). The corresponding circuit consists of relatively many, somewhat expensive, components and is correspondingly complex.

U.S. Pat. No. 6,351,079 B1 discloses a device for actuating an LED array (cluster) with at least two LED branches (chains) connected in parallel. All current to the LED array is controlled. The current is measured and correspondingly controlled in each LED branch. To do this, each LED branch contains a transistor, a resistor, and a measuring device. The control is carried out by means of a control device in the form of a microprocessor. The device is complex and correspondingly expensive.

A circuit disclosed in US 2004/0036418 A1 with the control circuit is likewise very complex and expensive.

A first object of the invention is to provide a method to supply power to an LED array in which symmetrical current distribution is achieved to individual LED branches economically and with simple means.

The first object is achieved through a method having the features of claim 1. One of the LED branches is selected to be the master whose current is utilized as the target specification for the remaining LED branches. In this manner, a very simply constructed circuit can be used, which has only a few components. These components can also be very simple, which means that the circuit can be produced in a manner that is, as a whole, economical. This ensures symmetrical current distribution to the individual LED branches. This applies, in particular, in the event that one LED branch would have a high-impedance failure, for example due to a defective LED, because then the current in the remaining LED branches could then be reduced to the extent that these LED branches could also be switched off. This also enables simple and clear fault detection, even with conventional control units, which are typically designed for the detection of the failure of bulbs. The essentially equalized branch currents in the individual LED branches are solely determined via the total current (which can be predetermined to a great extent) applied by the source current. Further adjustments are not necessary. Differences in the forward voltages of the loads, in this case the LEDs, are automatically compensated for by the method according to the invention; the same thing applies to dynamic changes and non-linearity. Mixed populations with LEDs having different forward voltages are also compensated for.

In particular, LED branches that are very different—i.e., those with great differences in the number and/or type of LEDs and thus in the current needs—are easy to control in defined ratios with respect to one another in the LED branches. The known methods are not capable of doing this or only at great expense.

If, according to an advantageous embodiment of the method, the LED branch selected as the master is the one having the greatest string voltage, then the symmetrical current distribution to the LED branches is particularly easy to implement.

Further objects of the present invention are the provision of a circuit arrangement for implementing the method according to the invention as well as a lighting unit with said circuit arrangement.

Said objects are achieved by means of a circuit arrangement having the features of claim 3 and through a lighting unit having the features of claim 9, wherein the lighting unit represents a preferred practical application of the invention.

The circuit arrangement for an LED array comprises a current source, which is connected to the LED array in series, at least two LED branches connected in parallel, in each of which at least one LED is connected in series, wherein one of the LED branches is determined to be the master, a controllable resistor in each of the LED branches that is not specified as being the master, a current measuring device in each of the LED branches, and control electronics for controlling the resisters such that the currents are in the defined, i.e. predetermined, ratio with respect to one another in the individual LED branches.

What has been said applies to the method accordingly.

The further dependent claims applied to the advantageous further embodiment of the circuit arrangement.

In one alternative, the current source comprises a control unit. Due to the precisely defined current applied hereby, the desired lighting properties of the LED array, such as, for example, the brightness are assured.

In a further alternative, the controllable resistors are designed as MOSFET or bipolar transistors. These are economical and robust standard components.

In a further alternative, the control electronics consist of operational enhancers according to the number of LED branches. The operational enhancers are also economical and robust standard components.

In a further embodiment, a switch is arranged in the LED branch that is determined to be the master. This means that if one of the LED branches fails, the master and thus the entire LED array can be switched off. This simplifies troubleshooting.

An advantageous further embodiment provides for the current source and the remaining circuit parts being designed as a single integrated component. This increases the compactness of the circuit arrangement and reduces the complexity of the wiring.

In another alternative embodiment, the current source is located on one side and the remaining circuit parts are located on the other side each as an integrated assembly. Thus, the current source forms one assembly and the remaining circuit parts form another assembly. This makes it possible for the different assemblies to be produced in various specialized plants.

The invention will be explained in greater detail by means of an exemplary embodiment, which is represented in the schematic drawing. The single FIGURE shows a circuit diagram of a circuit arrangement according to the invention.

The circuit arrangement shown in the FIGURE is part of a lighting unit designed as a vehicle headlamp (not shown in greater detail) and has a current source 2 that is electrically connected to an LED array 1 in series. The LED array 1 in this case represents a light source for the vehicle headlamp, for example for generating daytime running lights, and is supplied with power when the daytime running lights are switched on by the current source 2. The current is set to a predetermined value by a control unit 2a.

The LED array 1 in this case has three LED branches 3 electrically connected in parallel. However, more or only two LED branches 3 can also be configured. Each of the LED branches 3 has at least one LED 4 electrically connected in series. Furthermore, each of the LED branches 3 has a current measuring device 5 electrically connected to the LEDs 4 in series.

The current measuring devices 5 have a signal transmission connection with control electronics 6, which, in turn, have a signal transmission connection with controllable resistors 7 and a switch 8. The control electronics 6 comprise a plurality of operational enhancers according to the number of LED branches 3.

The LED branches 3 in this case have different numbers of similar LEDs; in this case, three, one, and two LEDs according to the FIGURE. The LED branch 3 with the largest string voltage, which is the LED branch 3 shown to the left in the figure, and has three LEDs, is determined to be the master 3a. Within this master LED branch 3a, the switch 8 is electrically connected to the LEDs 4 and the current measuring device 5 in series. Each of the remaining LED branches 3b, which thus are not determined to be the master 3a, contains one of the resistors 7, which is electrically connected to the LEDs 4 and the current measuring device 5 in series. Each of the resistors 7 is designed, for example, as a MOSFET or bipolar transistor.

The current source 2 and the remaining circuit parts, 3 to 8, in this case are designed as a single integrated assembly on one circuit board.

During operation, the daytime running lights for the vehicle headlamp are switched on, which causes current source 2 to supply LED array 1 with a predetermined amount of current, and LEDs 4 from LED array 1 illuminate. The resistors 7 are initially high-impedance. The switch 8 is closed.

By means of the current measuring devices 5, the respective flow of current in the LED branches 3 is measured and forwarded as an output signal for further processing to the control electronics 6. The measured currents are compared with one another in the control electronics 6 and the resistors 7 are controlled as a function of the comparison. In doing so, the resistors 7 are controlled by the control electronics 6 such that the currents in the individual LED branches 3 of the LED array 1 have the predetermined ratio with respect to one another, wherein the current flowing in the master 3a is determined to be the control variable.

This occurs independently of the total current, which is adjustable and dependent on the respective application case to a great extent, being fed into the LED array 1 by the current source 2. Specifically, the control electronics 6 check, by means of the aforementioned comparison, in which the LED branch 3b of the current deviates from the specification, i.e. the predetermined condition. If, for example, the current is insufficient in the LED branch 3b to the right in the FIGURE, the resistor value of the resistor 7 in this LED branch 3b will be suppressed by the control electronics 6, i.e. the current in the LED branch 6 will be controlled until the current flow in the LED branch 3b has the defined ratio with respect to the master 3a. On the other hand, if the current is too high, the resistor value of the resistor 7 will be increased accordingly.

The invention is not limited to the exemplary embodiment shown. For example, the number of LED branches 3b and the LEDs 4 in the individual branches can be selected to a great extent. For example, an advantage of the invention is that the number of LEDs 4 can differ from one another per LED branch 3. It is also conceivable that an individual LED branch 3 or various LED branches 3 could have various types of LEDs 4 with forward voltages being applied that deviate from one another.

The individual LED branches 3 can have currents that deviate from one another. In this case, fixed ratios of currents of, for example, 70%/30% or 50%/50% with two LED branches 3 or 40%/30%/30% with three LED branches 3 can be configured.

### LIST OF REFERENCE SYMBOLS

1 LED array
2 Current source
3 (a, b) LED branch
4 LED
5 Current measuring device
6 Control electronics
7 Resistor
8 Switch

1. A method to supply power to an LED array (1), comprising at least two LED branches (3) connected in parallel, in each of which at least one LED (4) is arranged; wherein the LED array (1) is supplied with predetermined current from a current source (2) connected in series; wherein currents are measured in the LED branches (3); wherein the measured currents are compared in control electronics (6); wherein the currents are controlled in one part of the LED branch (3) such that they are in a defined ratio with respect to one another in all LED branches (3); characterized in that one of the LED branches (3) is selected to be the master (3a) whose current is utilized as the target specification for the remaining LED branches (3b).

2. The method according to claim 1, characterized in that the LED branch selected as the master (3a) is the one having the largest string voltage.

3. Circuit arrangement for an LED array (1) comprising
A current source (2) that is connected to the LED array (1) in series;
At least two LED branches (3) connected in parallel in each of which at least one LED (4) is connected in series, wherein one of the LED branches is determined to be the master (3a);
A controllable resistor (7) in each of the LED branches (3b) that is not specified as being the master (3a);
A current measuring device (5) in each of the LED branches (3); and
Control electronics (6) for controlling the resistors (7) such that the currents are in a defined ratio with respect to one another in the individual LED branches (3).

4. The circuit arrangement according to claim 3, characterized in that the current source (2) comprises a control unit (2a).

5. The circuit arrangement according to claim 3, characterized in that, the resistors (7) are designed as MOSFET or bipolar transistors.

6. The circuit arrangement according to claim 3, characterized in that the control electronics (6) consists of operational enhancers according to the number of LED branches (3).

7. The circuit arrangement according to claim 3, characterized in that a switch (8) is arranged in the LED branch (3a) that is determined to be the master (3a).

8. The circuit arrangement according to claim 3, characterized in that the current source (2) and the remaining circuit parts (2 through 8) are designed as a single integrated assembly.

9. The circuit arrangement according to claim 3, characterized in that the current source (2) is located on one side and the remaining circuit parts (2 through 8) are located on the other side and designed as a single integrated assembly.

10. A lighting unit, particularly for a motor vehicle, having a circuit arrangement according to claim 3.
